(19) United States
(12) Patent Application Publication
(10) Pub. No.: US 2016/0297301 A1
(43) Pub. Date: Oct. 13, 2016

(54) MODULAR UNIT IDENTIFICATION IN A MODULAR UPGRADEABLE VEHICLE INFOTAINMENT SYSTEM

(71) Applicant: Panasonic Automotive Systems Company of America, Division of Panasonic Corporation of North America, Peachtree City, GA (US)

(72) Inventors: HANS A. TROEMEL, JR., SHARPSBURG, GA (US); THOMAS R. BURNS, ATLANTA, GA (US); VOLODYMYR RIAZANTSEV, PEACHTREE CITY, GA (US); SERGII POSTULGA, PEACHTREE CITY, GA (US)

(73) Assignee: Panasonic Automotive Systems Company of America, Division of Panasonic Corporation of North America

(21) Appl. No.: 15/089,789

(22) Filed: Apr. 4, 2016

Related U.S. Application Data
(60) Provisional application No. 62/144,076, filed on Apr. 7, 2015.

(51) Int. Cl. B60K 35/00; G01S 19/13; B60R 1/00

(52) U.S. Cl. CPC B60K 35/00; B60R 1/00; G01S 19/13; B60R 2300/8066

(57) ABSTRACT

An infotainment arrangement for a motor vehicle includes a non-permanent upgradeable portion non-permanently installed in the vehicle and replaceable in the vehicle. The non-permanent upgradeable portion has an electrical characteristic unique to a type or model of the non-permanent upgradeable portion. A permanent portion is in electronic communication with the non-permanent upgradeable portion. The permanent portion includes a plurality of non-upgradeable electronic components. The permanent non-upgradeable portion is permanently installed in the vehicle. The permanent non-upgradeable portion senses the unique electrical characteristic and thereby identifies the type or model of the non-permanent upgradeable portion.

### CROSS-REFERENCE TO RELATED APPLICATIONS

This application claims the benefit of U.S. Provisional Application No. 62/144,076 filed on Apr. 7, 2015, which the disclosure of which is hereby incorporated by reference in its entirety for all purposes.

### FIELD OF THE INVENTION

The disclosure relates to an infotainment system for a motor vehicle for any mode of transportation.

### BACKGROUND OF THE INVENTION

Infotainment systems on motor vehicles are generally not upgradeable. The consumer electronics market not only changes software but continuously upgrades the electronics as well. This constant rapid evolution of the consumer market quickly forces the electronics of the infotainment system to become obsolete within a few years, and yet the vehicle may be in service for over ten years. Thus, the majority of a vehicle's life may be spent with obsolete electronics.

### SUMMARY

Disclosed herein is a system partitioning and architecture wherein it is possible to upgrade, swap out, or exchange a module or modules which may include wired and/or wireless in-cabin interfaces. The module(s) may be upgraded, swapped out, or exchanged to communicate with consumer electronics, to upgrade the processing of vehicle/infotainment audio/video/data, and/or to increase internet/data bandwidth for vehicle/infotainment applications. The method disclosed herein provides the ability to identify and detect the presence of an exchangeable module.

The system partitioning/architecture provides a physical division between the permanent automotive-specific original equipment manufacturer (OEM) vehicle-centric components and the modular upgradable components. The permanent components may include an external radio frequency (RF) interface (e.g., broadcast audio systems, broadcast television systems, cellular systems, global navigation satellite system (GNSS) receivers, wireless transceivers, etc.), audio power amplifiers, automotive displays/clusters/heads up displays (HUD), and/or vehicular communication buses. All of these elements may be tailored or tuned to the vehicle for best performance or styling. In contrast, the modular upgradeable components may include the main processor or system on chip (SoC) of the infotainment system along with the latest electronic, mechanical, or software interfaces to the consumer devices (e.g., phones, tablets, etc.). The permanent and modular systems may be connected via high bandwidth bi-directional audio/video/data communication buses and signaling.

The invention may provide the ability to upgrade the vehicle infotainment system with minimal impact to the factory-installed vehicle systems over the lifetime of the vehicle. This architecture provides the ability to keep better pace with the current state of consumer electronics, while possibly adding features to the vehicle system in the future as well. In essence, the inventive architecture future-proofs the vehicle infotainment system. The architecture enables quick and cost effective upgrading of the components of the system that are most likely to be in need of an upgrade in the future.

In one embodiment, the invention comprises deploying a basic but complete infotainment system on all vehicles, and then adding any additional desired components or features for certain models of vehicles without impacting the base system.

The architecture binds the system to the elements that are vehicle specific, leaving open many possible upgrade paths that are more specific to the human-machine interface (HMI), user experience, external connectivity, and other technologies that are not necessarily a part of the vehicle-specific components.

A core hardware system can be qualified for use and deployed across a broad range of vehicles. The features or capabilities are upgraded without having knowledge in advance of what those features or capabilities might be, because the core system can hand over control to one of the newly installed components. These upgrades can be installed without having to re-qualify the already installed components.

The system may be upgraded by replacement and/or exchanging of the modular units. This approach avoids system redundancy and maintains cost effectiveness. In one embodiment, a factory installed unit has a main system on chip (SoC) and connections with a blank or empty dock. This approach saves the cost of the modular unit housing and power supplies. This method is valid, but provides redundancy to the overall system cost once the first modular unit is applied.

In one embodiment, the invention comprises an infotainment arrangement for a motor vehicle including a non-permanent upgradeable portion non-permanently installed in the vehicle and replaceable in the vehicle. The non-permanent upgradeable portion has an electrical characteristic unique to a type or model of the non-permanent upgradeable portion. A permanent portion is in electronic communication with the non-permanent upgradeable portion. The permanent portion includes a plurality of non-upgradeable electronic components. The permanent upgradeable portion is permanently installed in the vehicle. The permanent upgradeable portion senses the unique electrical characteristic and thereby identifies the type or model of the non-permanent upgradeable portion.

In another embodiment, the invention comprises a method of maintaining an infotainment system in a motor vehicle, including non-permanently installing a non-permanent upgradeable portion of the infotainment system in the vehicle. The non-permanent upgradeable portion includes an electrical characteristic unique to a type or model of the non-permanent upgradeable portion. A permanent portion of the infotainment system is permanently installed in the vehicle. The permanent portion includes a plurality of non-upgradeable electronic components. Electronic communication is performed between the permanent portion and the non-permanent upgradeable portion. The unique electrical characteristic sensed and the type or model of the non-permanent upgradeable portion is identified based on the sensing.

In yet another embodiment, the invention comprises a method of maintaining an infotainment system in a motor vehicle. A non-permanent upgradeable portion of the infotainment system is non-permanently installed in the vehicle. The non-permanent upgradeable portion includes a resistor having a resistance unique to a type or model of the non-permanent upgradeable portion. A permanent portion of the infotainment system is permanently installed in the vehicle. The permanent portion includes a plurality of non-upgradeable electronic components. The permanent portion is connected to the non-permanent upgradeable portion. A voltage or current associated with the resistor is sensed. The type or model of the non-permanent upgradeable portion is identified based on the sensing. After the identification of the upgradable portion has been established, the same signal line may or may not be utilized as a general purpose input or output for a different system application.

### BRIEF DESCRIPTION OF THE DRAWINGS

A better understanding of the present invention will be had upon reference to the following description in conjunction with the accompanying drawings.

FIG. 1 is a block diagram of one example embodiment of a vehicle infotainment system of the present invention.

FIG. 2 is a schematic diagram of one example embodiment of a presence and/or identification modular unit utilizing a voltage divider circuit of the present invention.

FIG. 3 is an example table of percentage shifts in DC voltage in the circuit of FIG. 2 and corresponding modular unit identities and/or presence.

FIG. 4 is a flow chart of one example embodiment of a modular unit identification method of the present invention.

FIG. 5 is a schematic diagram of one example embodiment of a presence and/or identification modular unit utilizing a current divider circuit of the present invention.

FIG. 6 is a schematic diagram of one example embodiment of a presence and/or identification modular unit utilizing a voltage summer circuit of the present invention.

FIG. 7 is a schematic diagram of one example embodiment of a presence and/or identification modular unit utilizing a current summer circuit of the present invention.

### DETAILED DESCRIPTION OF THE PREFERRED EMBODIMENTS

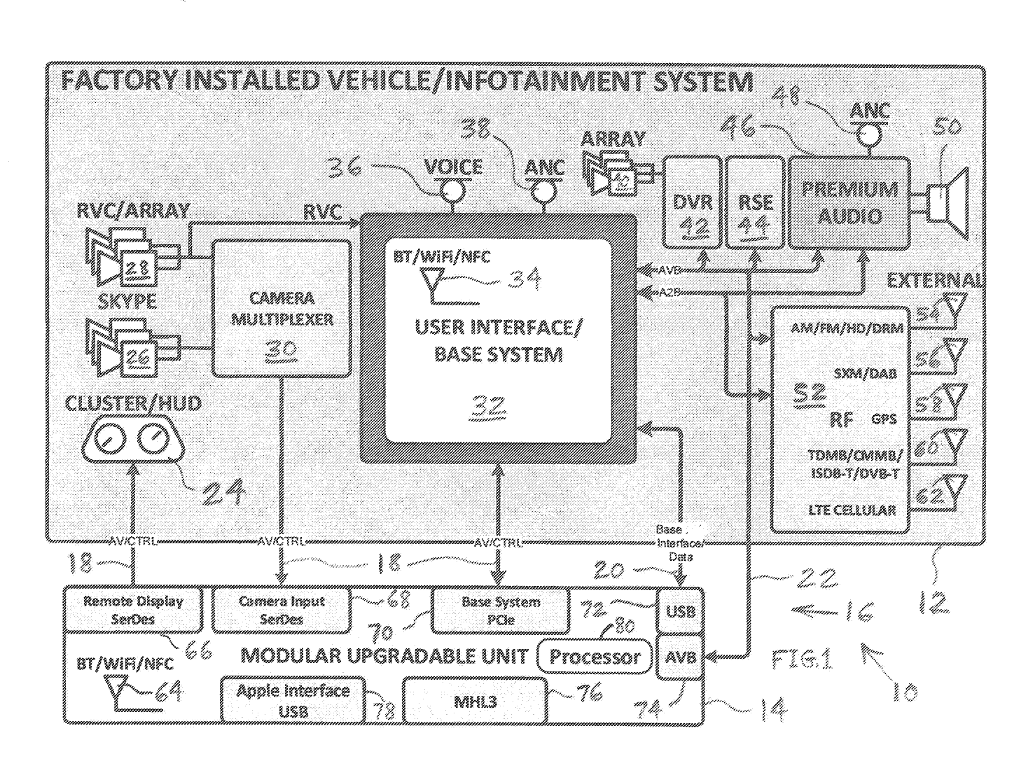

FIG. 1 illustrates one embodiment of a vehicle infotainment system 10 of the present invention including a permanent factory installed portion 12 and an upgradeable modular unit 14. Each of permanent portion 12 and modular unit 14 may be contained in a separate, respective housing. Permanent portion 12 and modular unit 14 may be interconnected by a connector arrangement 16 including one or more cables and connectors. The conductive lines within the connector arrangement 16 include audio/video data bus with control signaling 18, a base interface/data signaling 20, and an audio/video bridge (AVB) signaling 22 which may carry time-stamped Ethernet data.

Audio/video data bus with control signaling 18 may carry uncompressed data without any latency. In one embodiment, audio/video data bus with control signaling 18 may carry about three gigabits of data in each direction. One of these control signals may be utilized in the detection and/or presences method discussed herein.

In the embodiment shown, permanently factory installed portion 12 includes an instrument cluster/heads up display (HUD) 24, Skype cameras 26, Rear View Camera (RVC)/array cameras 28, a camera multiplexer 30, a user interface/base system 32 having a BT (Bluetooth)/WIFI/NFC (near field communication) antenna 34, a voice microphone 36, an ancillary microphone 38, a camera array 40, a digital video recorder (DVR) 42, rear seat entertainment (RSE) subsystem 44, a premium audio subsystem 46, an ancillary microphone 48, a loudspeaker 50, and a radio frequency (RF) antenna array 52 including an AM/FM/high definition (HD)/digital radio mondiale (DRM) antenna 54, a SiriusXM (SXM)/digital audio broadcasting (DAB) antenna 56, a global positioning system (GPS)/GNSS antenna 58, a Terrestrial-Digital Multimedia Broadcasting (T-DMB)/China Mobile Multimedia Broadcasting (CMMB)/Integrated Services Digital Broadcasting-Terrestrial (ISDB-T)/Digital Video Broadcasting-Terrestrial (DVB-T) antenna 60, and a long-term evolution (LTE) cellular antenna 62.

In the embodiment shown, upgradeable modular unit 14 includes a BT/WiFi/NFC antenna 64, a remote display serializer/deserializer 66, a camera input serializer/deserializer 68, a base system PCle 70, a USB port 72, an audio/video bridge 74, mobile high-definition link (MHL3) 76, an Apple Interface USB port 78, and a microprocessor 80 in communication with each of the other above-identified components of upgradeable modular unit 14. Apple Interface USB port 78 may be connectable to a personal electronic device, such as a mobile phone. A processor in the personal electronic device may be used as the primary processor of, and may perform most of the processing for, vehicle infotainment system 10.

During use, the components of upgradeable modular unit 14 may become obsolete due to age and/or better or more widely accepted technology coming to the consumer electronics market. When such obsolescence of one or more of the components of upgradeable modular unit 14 occurs, the owner of the vehicle may swap out the obsolete modular unit 14 with an upgraded modular unit 14. The owner of the vehicle may swap out modular unit 14 himself by disconnecting the obsolete modular unit 14 from the vehicle dashboard. In one embodiment, modular unit 14 may be disconnected from the vehicle dashboard simply by pulling modular unit 14 out of a recess in the dashboard in a single linear motion. Similarly, the new, upgraded modular unit 14 may be inserted into the dashboard by simply pushing modular unit 14 into the recess in the dashboard in a single linear motion until it snaps into place. The new, upgraded modular unit 14 may be fully mechanically and electrically connected to the dashboard as soon as the upgraded modular unit 14 snaps into place. The direction of pushing may be in a direction opposite to the direction in which unit 14 was pulled out during removal. Modular unit 14 may be hot swappable such that the new modular unit 14 is operable as soon as it is snapped into place.

In another embodiment, specialized or customized tools are required to remove the obsolete modular unit 14 from the dashboard such that replacing modular unit 14 with another one must be performed by personnel at the dealership who have the required tools.

Within the automotive OEM market, modular and replaceable units are not common. However, because a single permanent, factory-installed unit may be operated with several modular replaceable units over its lifetime, there is a need for the permanent unit to identify the type or model of the modular replaceable unit that it is currently connected to. If no modular replaceable unit is currently present and connected, then the permanent unit may need to determine that absence as well.

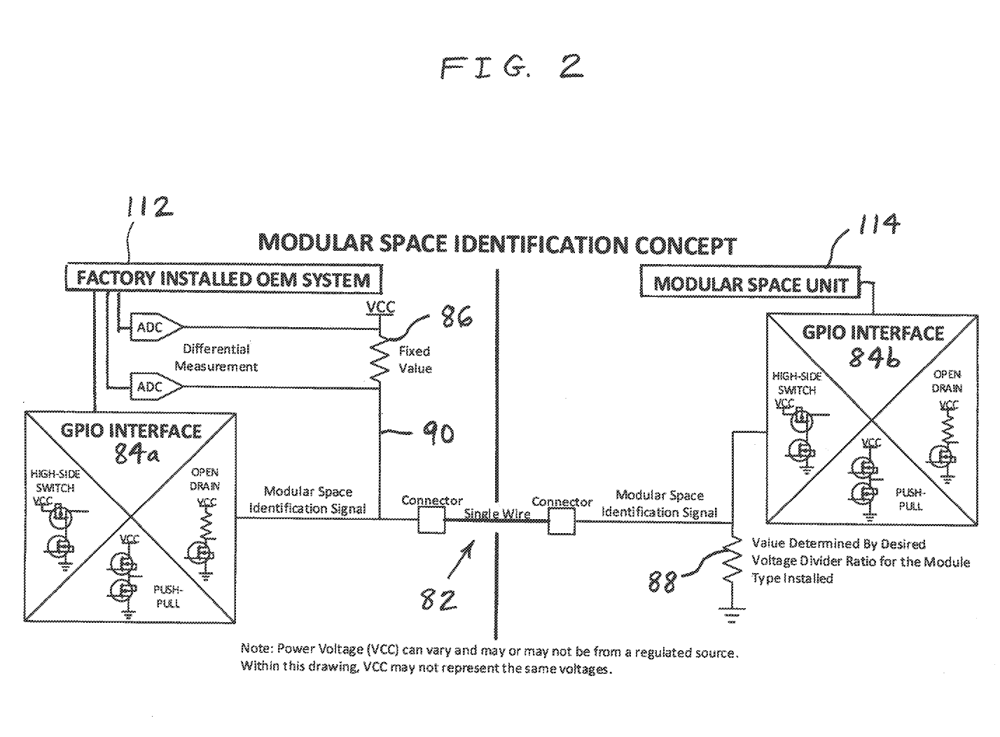

In one embodiment, a single wire connection 82 (FIG. 2) establishes the identification and/or absence of a modular replaceable unit 114 or automotive component/vehicle model/host system that can be repurposed during normal operation to a logical general purpose input/output (GPIO) interface 84a-b between the modular replaceable unit 114 and a permanently factory installed unit 112. Both the factory installed portion 84a of the GPIO interface and the modular portion 84b of the GPIO interface may include a high-side switch, a push-pull, or an open drain configuration. The type of each portion 84a-b may be independent of the other, such that the types of GPIO portions 84a-b may be mixed and matched. For example, portion 84a may be a high-side switch configuration while portion 84b is a push-pull configuration, etc.

The absence or identification of modular unit 114 may be indicated by a DC shift within the bias of the modular space identification signal relative to a power source during the initialization procedure. A portion of the detection circuit is implemented within the host/factory OEM system 112 and a portion is implemented within the modular replaceable unit 114. The circuit is not complete until both units 112, 114 are connected. The measurement is taken as a differential or ratiometric relative to the power source. This method enables an unregulated power source, such as batteries, to be utilized without influencing the results. The absence of the modular unit 114 is indicated by there being no DC shift. For example, in the absence of any modular unit 114, there may be no voltage drop across resistor 86, or the voltage drop across resistor 86 may be less than 5% of the voltage value of VCC. Each particular type of modular unit 114 may have a different characteristic resistance value of its resistor 88, thereby causing a different DC shift or voltage drop across resistor 86. Factory installed system 112 may measure the voltage on both ends of resistor 86.

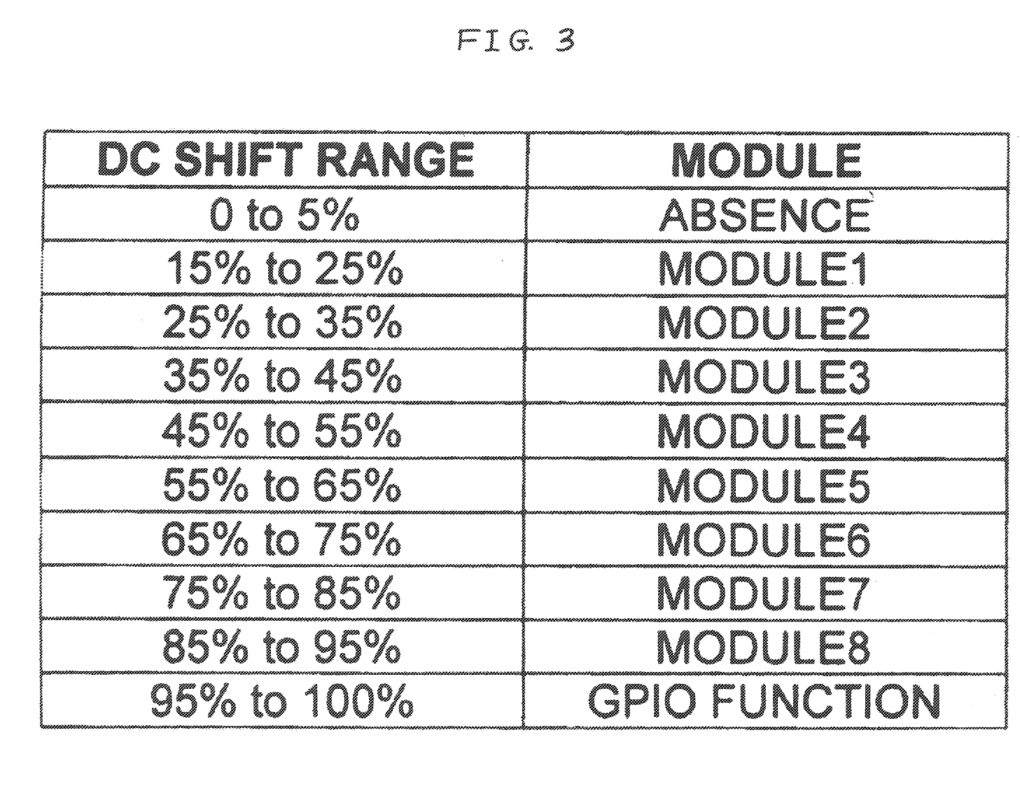

An example of the identification process is the DC shift is divided into percentage windows or ranges that are relative to the voltage of the power source, and each range is assigned to a corresponding module or host system. This technique provides a single wire method for identification with tolerance granularity for noise margin. An example of this technique may be described with reference to the table of FIG. 3. As mentioned above, a DC shift between 0 and 5% of VCC may indicate that no modular unit 114 is connected to factory system 112. One particular type of modular unit 114, referred to as “MODULE 1” in FIG. 3, may have a resistor 88 with a resistance value such that the DC shift (e.g., the voltage drop across resistor 86 as a percentage of VCC) is approximately between 15% and 25%; another particular type of modular unit 114, referred to as “MODULE 2” in FIG. 3, may have a resistor 88 with a resistance value such that the DC shift (e.g., the voltage drop across resistor 86 as a percentage of VCC) is approximately between 25% and 35%, etc. Accordingly, by measuring the DC shift and referencing the table of FIG. 3, which may be stored in memory of factory system 112, the absence or type of connected modular unit 114 may be determined.

Once the modular unit identification process is complete, the wire 82 can be re-purposed to be utilized as the GPIO indication for other functions. Since the GPIO function/communication may be based upon logical level or edge, tolerances may be established on the edges or limits of the DC shift ranges, as indicated within the table of FIG. 3. The DC bias shift may be monitored continuously to check for the removal (i.e., absence) of the modular unit 114, and the identification process may start over if the absence of the modular unit 114 is indicated consistently over a period of time (e.g., over a period of at least five seconds).

This inventive module identification arrangement includes a multi-functional single wire robust implementation to provide initial module identification and/or absence along with GPIO functionality during operation within an automotive environment. The module identification arrangement can identify the modular systems and/or host/vehicle system.

The inventive module identification arrangement may operate independent of power supply variations due to the ratiometric nature of the measurements. In addition, the re-purposing of the single wire or pin to create a GPIO function after the identification process is complete can be independent of the logic operational voltage. All of this functionality is accomplished over a single wire connection relative to a common ground.

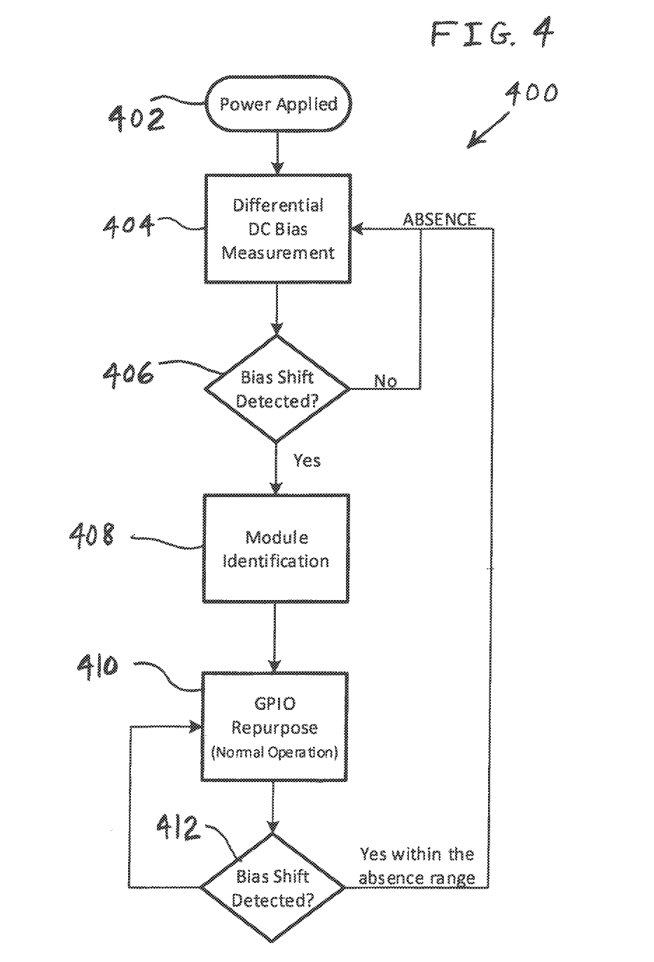

One embodiment of a replaceable modular unit identification method 400 of the present invention is shown in FIG. 4. In a first step 402, power is applied at VCC directly to resistor 86.

In a second step 404, a differential DC bias is measured. If VCC is known, a voltage at node 90 may be measured. If VCC is not known, then VCC may also be measured.

Next, in step 406, it is determined whether a bias shift is detected. For example, if no modular unit 114 is present, then resistor 86 may not be connected to ground, and thus the voltage at node 90 may be equal to, or within 5% of, VCC. That is, there may be no bias shift. Operation returns to step 404 where the differential DC bias may continue to be monitored. However, if no modular unit 114 is present, then resistor 86 may be connected to ground through resistor 88, and thus the voltage at node 90 may be less than about 95% of VCC. That is, there may be a bias shift, and operation may proceed to step 408.

In step 408, the module is identified. For example, the measured DC bias, or “DC Shift Range” may be found in the table of FIG. 3 to look up which replaceable module is present.

Next, in step 410, the infotainment system may return to normal operation, and the GPIO is re-purposed. That is, the single wire 82 may be used to carry signals between the factory OEM system 112 and the modular unit 114 that are related to operation of the infotainment system rather than identification of the modular unit 114.

In a final step 412, monitoring of the bias shift continues. For example, if modular unit 114 is removed from the vehicle, then no bias shift may be detected, or the bias shift may be within the absence range of approximately between 0 and 5%. Operation then returns to step 404 where the differential DC bias may continue to be measured and monitored. However, if modular unit 114 is still present, then there may still be a bias shift of greater than 5%, and operation returns to step 410.

In another embodiment (not shown), the fixed and variable resistor positions are swapped between the factory installed OEM system and the modular space unit. That is, the variable resistor in the replaceable modular unit may be connected directly to VCC, and the fixed resistor in the permanent unit may be connected directly to ground. The shunt resistor tied to ground may be provided within the factory installed OEM system, and the high side resistor may be provided within the modular space unit.

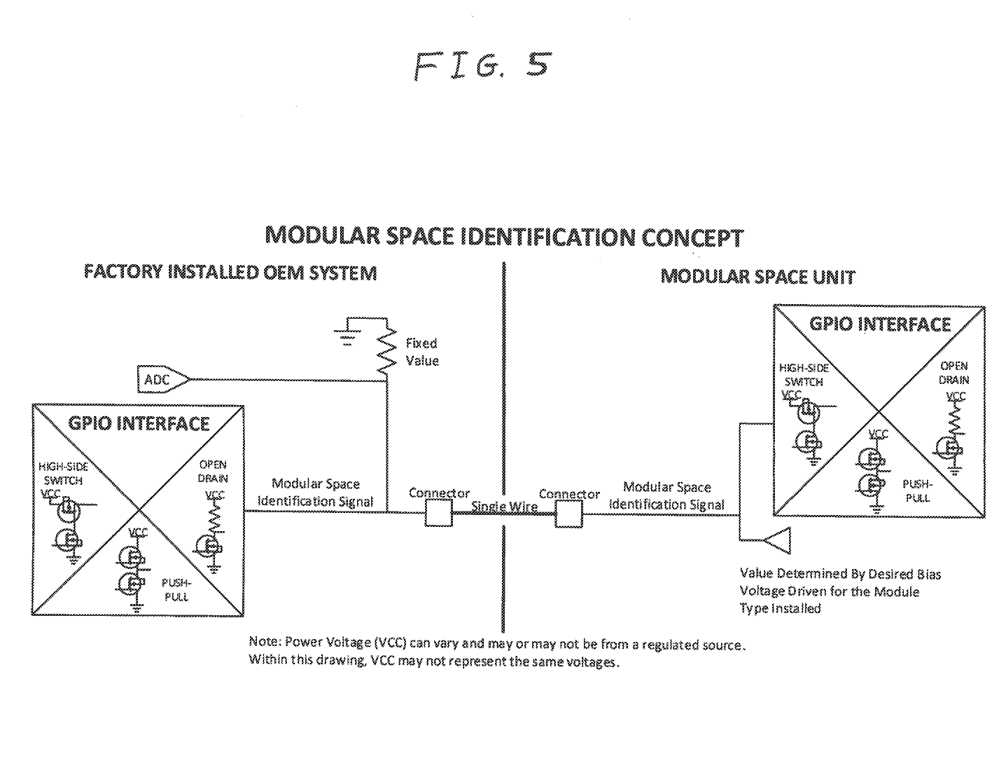

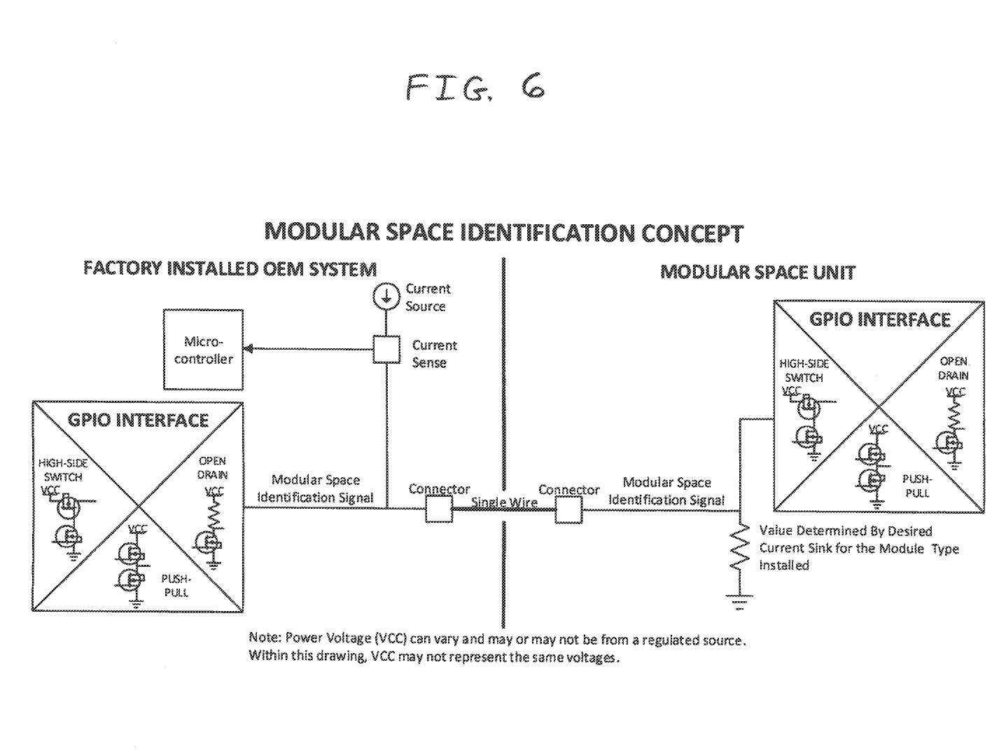

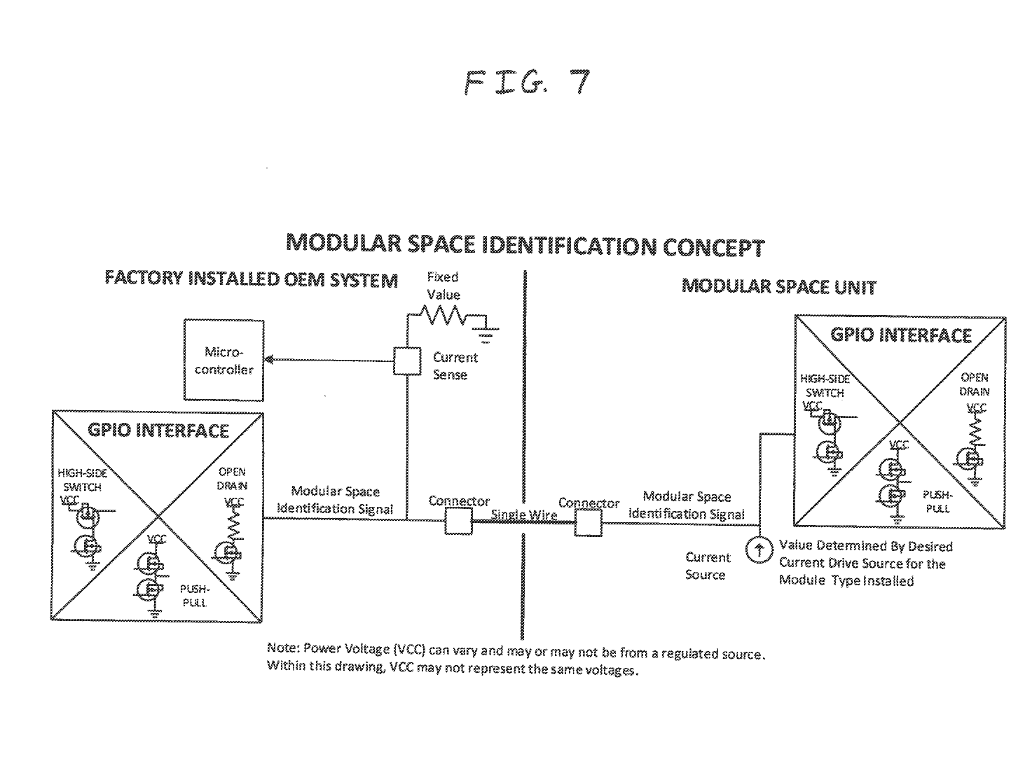

It is also possible, in other embodiments, to use other circuit topologies other than a voltage divider for module identification. For example, FIG. 5 illustrates a current divider arrangement; FIG. 6 illustrates a current summer arrangement; and FIG. 7 illustrates a voltage summer arrangement.

The foregoing detailed description is given primarily for clearness of understanding and no unnecessary limitations are to be understood therefrom for modifications can be made by those skilled in the art upon reading this disclosure and may be made without departing from the spirit of the invention.

What is claimed is:

1. An infotainment arrangement for a motor vehicle, comprising:
a non-permanent upgradeable portion configured to be non-permanently installed in the vehicle and to be replaceable in the vehicle, the non-permanent upgradeable portion having an electrical characteristic unique to a type or model of the non-permanent upgradeable portion; and
a permanent portion in electronic communication with the non-permanent upgradeable portion, the permanent portion including a plurality of non-upgradeable electronic components, the permanent portion being configured to:
be permanently installed in the vehicle; and
sense the unique electrical characteristic and thereby identify the type or model of the non-permanent upgradeable portion.

2. The arrangement of claim 1 wherein the non-permanent upgradeable portion is connected to the permanent portion by at least one cable or connector.

3. The arrangement of claim 1 wherein the electrical characteristic of the non-permanent upgradeable portion comprises a resistance value of a resistor of the non-permanent upgradeable portion.

4. The arrangement of claim 3 wherein the resistor of the non-permanent upgradeable portion comprises a first resistor, the permanent portion including a second resistor connected in series with the first resistor, the permanent portion being configured to sense the resistance value of the first resistor by determining a voltage drop across the second resistor.

5. The arrangement of claim 1 wherein the non-permanent upgradeable portion is configured to be removed from the vehicle by pulling the non-permanent upgradeable portion out of the vehicle in a first single, linear motion in a first direction, and the non-permanent upgradeable portion is configured to be installed in the vehicle by pushing the non-permanent upgradeable portion into a recess of the vehicle in a second single, linear motion in a second direction opposite to the first direction until the non-permanent upgradeable portion snaps into place.

6. The arrangement of claim 1 wherein the electrical characteristic of the non-permanent upgradeable portion comprises a level of current output of a current source of the non-permanent upgradeable portion.

7. The arrangement of claim 1 wherein the electrical characteristic of the non-permanent upgradeable portion comprises a level of voltage output of a voltage source of the non-permanent upgradeable portion.

8. A method of maintaining an infotainment system in a motor vehicle, comprising:
non-permanently installing a non-permanent upgradeable portion of the infotainment system in the vehicle, the non-permanent upgradeable portion including an electrical characteristic unique to a type or model of the non-permanent upgradeable portion;
permanently installing a permanent portion of the infotainment system in the vehicle, the permanent portion including a plurality of non-upgradeable electronic components;
performing electronic communication between the permanent portion and the non-permanent upgradeable portion;
sensing the unique electrical characteristic; and
identifying the type or model of the non-permanent upgradeable portion based on the sensing.

9. The method of claim 8 wherein the electrical characteristic of the non-permanent upgradeable portion comprises a resistance value of a resistor of the non-permanent upgradeable portion.

10. The method of claim 9 wherein the resistor of the non-permanent upgradeable portion comprises a first resistor, the permanent portion including a second resistor connected in series with the first resistor, the method further comprising using the permanent portion to sense the resistance value of the first resistor by determining a voltage drop across the second resistor.

11. The method of claim 8 further comprising connecting the non-permanent upgradeable portion to the permanent portion by at least one cable or connector.

12. The method of claim 11 further comprising:
communicatively coupling the non-permanent upgradeable portion to a personal electronic device; and
using a processor in the personal electronic device to perform a majority of processing required by the system.

13. The method of claim 8 further comprising:
removing the non-permanent upgradeable portion from the vehicle by pulling the non-permanent upgradeable portion out of the vehicle in a first single, linear motion in a first direction; and
installing the upgraded non-permanent portion in the vehicle by pushing the upgraded non-permanent portion into a recess of the vehicle in a second single, linear motion in a second direction opposite to the first direction.

14. The method of claim 8 wherein the electrical characteristic of the non-permanent upgradeable portion comprises a level of current output of a current source of the non-permanent upgradeable portion.

15. The method of claim 8 wherein the electrical characteristic of the non-permanent upgradeable portion comprises a level of voltage output of a voltage source of the non-permanent upgradeable portion.

16. The method of claim 8 wherein the permanent portion performs the sensing.

17. A method of maintaining an infotainment system in a motor vehicle, comprising:
non-permanently installing a non-permanent upgradeable portion of the infotainment system in the vehicle, the non-permanent upgradeable portion including a resistor having a resistance unique to a type or model of the non-permanent upgradeable portion;
permanently installing a permanent portion of the infotainment system in the vehicle, the permanent portion including a plurality of non-upgradeable electronic components;
connecting the non-permanent upgradeable portion to the permanent portion;
sensing a voltage and/or a current associated with the resistor; and
identifying the type or model of the non-permanent upgradeable portion based on the sensing.

18. The method of claim 17 wherein the non-permanent upgradeable portion is connected to the permanent portion by at least one cable or connector.

19. The method of claim 17 further comprising:
communicatively coupling the non-permanent upgradeable portion to a personal electronic device; and
using a processor in the personal electronic device to perform a majority of processing required by the system.

20. The method of claim 17 further comprising:
removing the non-permanent upgradeable portion from the vehicle by pulling the non-permanent upgradeable portion out of the vehicle in a first single, linear motion in a first direction; and
installing the upgraded non-permanent portion in the vehicle by pushing the upgraded non-permanent portion into a recess of the vehicle in a second single, linear motion in a second direction opposite to the first direction.

21. The method of claim 17 wherein the resistor comprises a first resistor, the permanent portion including a second resistor electrically connected to the first resistor, the voltage associated with the first resistor comprises a voltage across the second resistor.

22. The method of claim 17 wherein the permanent portion performs the sensing.

23. The method of claim 17 further comprising performing electronic communication between the permanent portion and the non-permanent upgradeable portion.
